(19) United States
(12) Patent Application Publication
(10) Pub. No.: US 2022/0157164 A1
(43) Pub. Date: May 19, 2022

(54) Methods and Apparatus for Providing Information to a Remote Operator of a Vehicle

(71) Applicant: Nuro, Inc., Mountain View, CA (US)

(72) Inventors: Emily Anna WESLOSKY, Mountain View, CA (US); John David WEST, San Anselmo, CA (US); Aleena Pan BYRNE, San Mateo, CA (US); Eric YI, Foster City, CA (US); Yichao (Roger) Shen, Mountain View, CA (US)

(73) Assignee: Nuro, Inc., Mountain View, CA (US)

(21) Appl. No.: 17/504,386

(22) Filed: Oct. 18, 2021

Related U.S. Application Data
(60) Provisional application No. 63/115,434, filed on Nov. 18, 2020.

(51) Int. Cl. G08G 1/04; G06K 9/00; G08G 1/01

(52) U.S. Cl. CPC G08G 1/04; G08G 1/0104; G06K 9/00805

(57) ABSTRACT

According to one aspect, a method includes identifying, in a scene around a vehicle, at least a first object, wherein the at least first object is identified using data obtained from a sensor system of the vehicle. The method also includes determining a first type associated with the at least first object, identifying at least a first indicator associated with the first type, and providing the at least first indicator associated with the first type to a display arrangement configured to display the scene and the at least first indicator.

### PRIORITY CLAIM

This patent application claims the benefit of priority under 35 U.S.C. § 119 to U.S Provisional Patent Application No. 63/115,434, filed Nov. 18, 2020 and entitled “Methods and Apparatus for Providing Information to a Remote Operator of a Vehicle,” which is incorporated herein by reference in its entirety.

### TECHNICAL FIELD

The disclosure relates to providing systems for use with autonomous vehicles. More particularly, the disclosure relates to enhancing information provided to a remote operator of a vehicle to facilitate the remote monitoring and/or operation of the vehicle.

### BACKGROUND

A remote operator of vehicle, e.g., an operator of a teleoperation system or an operator of a remote control, must generally keep a close eye on a display screen which depicts the environment around the vehicle. The information displayed on the display screen is used by the remote operator to monitor the environment such that he or she may determine when to take control of the vehicle. The information displayed on the display screen is also used to allow the remote operator to accurately view the environment in which he or she is remotely operating the vehicle such that the vehicle may be operated safely.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4 is a block diagram representation of an overall system which allows for driving and supervisory modes to be presented on a display arrangement in accordance with an embodiment.

FIG. 5 is a process flow diagram which illustrates a method of displaying information on a display screen, e.g., for use by a remote operator or a teleoperator, in accordance with an embodiment.

FIG. 6 is a process flow diagram which illustrates a method of displaying a scene on a display arrangement with an overlay on an obstacle and/or context, e.g., step 529 of FIG. 5, in accordance with an embodiment.

FIG. 7 is a process flow diagram which illustrates a method of providing information on a display screen that includes providing a virtual console in accordance with an embodiment.

FIG. 8A is a diagrammatic representation of a display in which a feed, e.g., a scene, is displayed in accordance with an embodiment.

FIG. 8B is a diagrammatic representation of a display, e.g., display 850 of FIG. 8A, in which overlays are provided for obstacles in accordance with an embodiment.

FIG. 8C is a diagrammatic representation of a display, e.g., display 850 of FIG. 8B, in which movability of obstacles is indicated in accordance with an embodiment.

FIG. 8D is a diagrammatic representation of a display, e.g., display 850 of FIG. 8C, in which directions of movement are indicated for obstacles in accordance with an embodiment.

FIG. 9 is a diagrammatic representation of layouts of control indicators and notifications with respect to a display in accordance with an embodiment.

FIG. 10 is a block diagram representation of an overall system that includes a display processing system e.g., display processing system 448 of FIG. 4, which allows for driving and supervisory modes to be presented on a display arrangement, in addition to providing an indication of latency, in accordance with an embodiment.

FIG. 11 is a process flow diagram which illustrates a method of displaying latency information on a display screen, e.g., for use by a remote operator or a teleoperator, in accordance with an embodiment.

FIG. 12 is a diagrammatic representation of a display in which a stop fence is indicated in accordance with an embodiment.

### DESCRIPTION OF EXAMPLE EMBODIMENTS

General Overview

In accordance with one embodiment, a method includes identifying, in a scene around a vehicle, at least a first object, wherein the at least first object is identified using data obtained from a sensor system of the vehicle. The method also includes determining a first type associated with the at least first object, identifying at least a first indicator associated with the first type, and providing the at least first indicator associated with the first type to a display arrangement configured to display the scene and the at least first indicator. The first indicator may include a first overlay arranged to overlay the at least first object when the display is displayed by the display arrangement.

According to another embodiment, logic is encoded in one or more tangible non-transitory, computer-readable media for execution and, when executed, the logic is operable to identify, in a scene around a vehicle, at least a first object, wherein the at least first object is identified using data obtained from a sensor system of the vehicle. The logic is also operable to determine a first type associated with the at least first object, to identify at least a first indicator associated with the first type, and to provide the at least first indicator associated with the first type to a display arrangement configured to display the scene and the at least first indicator.

In accordance with still another embodiment, an apparatus includes a first element and a second element. The first element is configured to identify at least a first object in a scene around a vehicle using data obtained from the vehicle, the first element further being configured to determine a first type associated with the at least first object. The second element is configured to identify a first indicator associated with the first type, wherein the second element is further configured to provide the first indicator to a display element arranged to display the scene and the first indicator. The first indicator includes an overlay arranged to be displayed over the first object in the scene.

A system is provided which allows obstacles detected along the planned path of an autonomous or semi-autonomous vehicle to be highlighted on a display screen used by a remote party who may take control of, or may be controlling, the vehicle. The obstacles may be highlighted using overlays, contextual information, other visual cues, and/or audial cues. The types of highlighting used and/or the parameters associated with the highlighting may vary based upon an obstacle type, and may also be based upon whether a remote operator is monitoring a vehicle or is actively controlling the vehicle. In one embodiment, a display screen may also provide an indication of latency associated with communications between a vehicle and a system used by a remote operator.

Description

As the use of autonomous vehicles grows, the ability to safely operate autonomous vehicles is becoming more important. Many autonomous vehicles are actively monitored by remote operators during operation, using systems which are configured to display video and/or audio feeds, e.g., scenes, of the environments around the autonomous vehicles. For example, teleoperation systems and remote control systems are often used to monitor and/or to control autonomous vehicles, and generally.

To facilitate the use of teleoperations systems and remote control systems, displays of feeds or scenes may be augmented to provide supplemental information regarding objects in the feeds. The supplemental information may effectively clarify what is in a feed. as it may be difficult: to discern which objects in the feed are moving and/or have a significant potential to adversely affect the operations of a vehicle. In one embodiment, displays of feeds may identify objects that may be obstacles using visual indicators such as overlays, and may provide contextual information relating to such obstacles. An overlay may be arranged to identify a type of obstacle, while contextual information may indicate whether the obstacle is moving and/or a. direction of movement of the obstacle. The use of overlays and/or contextual information may allow a remote operator to readily identify obstacles in a feed, The ability to efficiently identify obstacles along a path of a vehicle may increase the likelihood that a remote operator may safely operate the vehicle, or safely take over the operation of the vehicle in the event that the presence of the obstacle substantially necessitates a takeover of control of the vehicle.

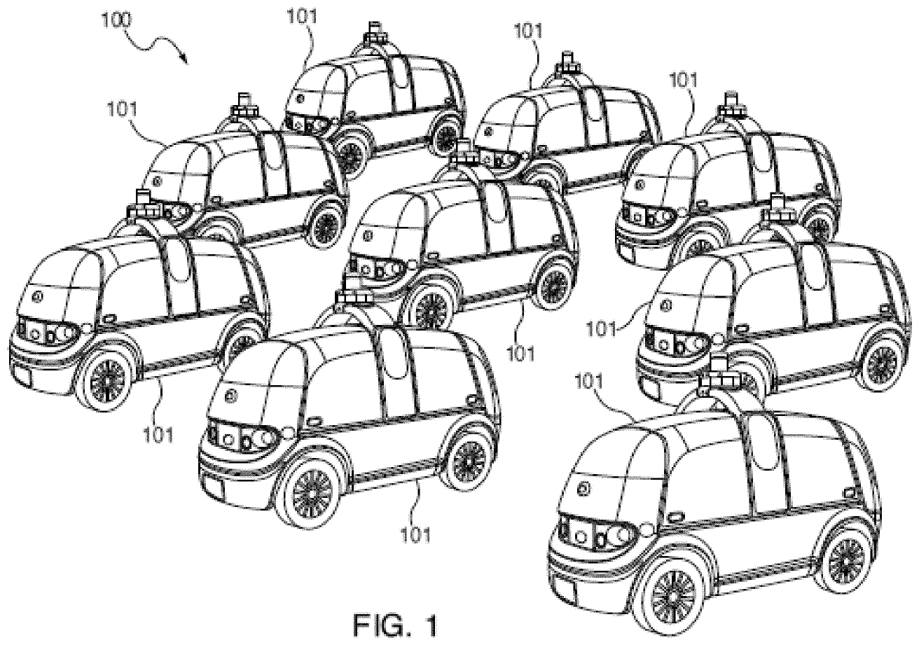

Vehicles within a fleet may be monitored and controlled, as appropriate, remotely by remote operators using a remote control and/or a teleoperation system. Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of traveling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment.

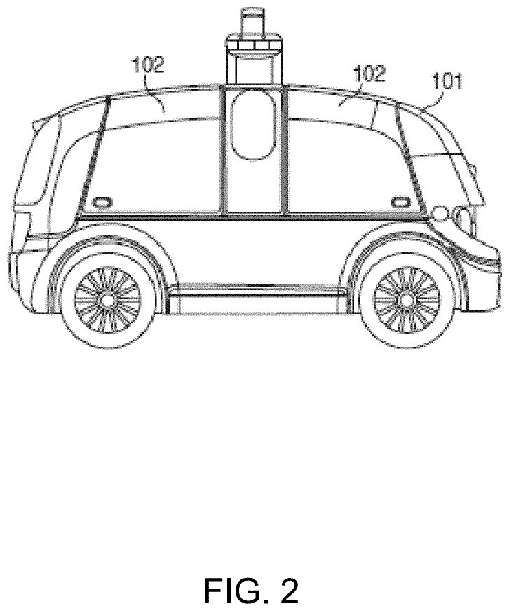

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

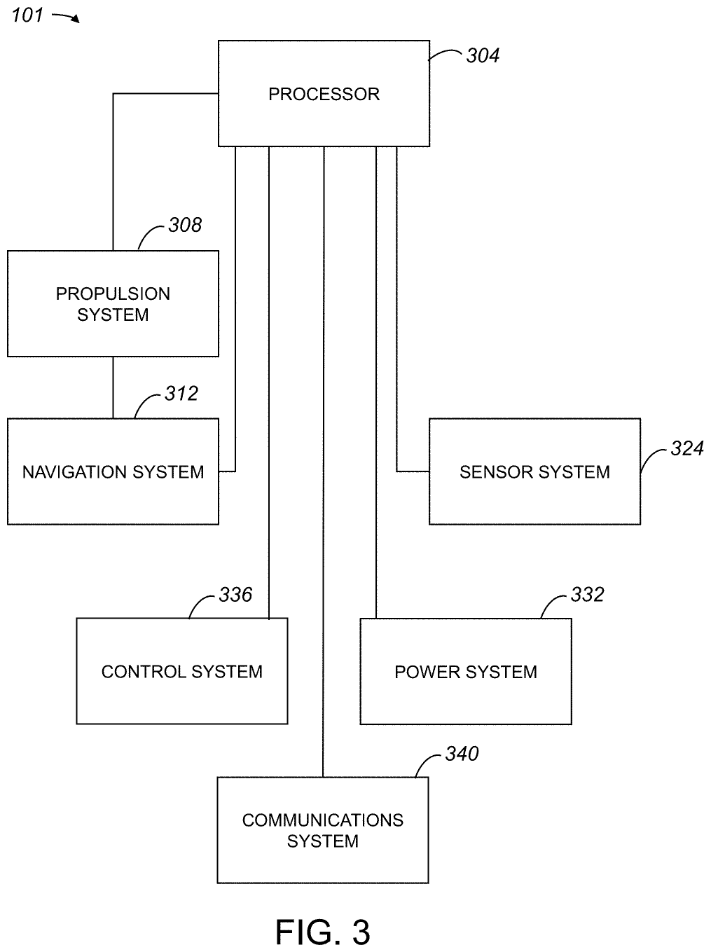

FIG. 3 is a block diagram representation of an autonomous vehicle, e.g., autonomous vehicle 101 of FIG. 1, in accordance with an embodiment. An autonomous vehicle 101 includes a processor 304, a propulsion system 308, a navigation system 312, a sensor system 324, a power system 332, a control system 336, and a communications system 340. It should be appreciated that processor 304, propulsion system 308, navigation system 312, sensor system 324, power system 332, and communications system 340 are all coupled to a chassis or body of autonomous vehicle 101.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment.

Sensor system 324 includes any sensors, as for example LiDAR, radar, ultrasonic sensors, microphones, altimeters, and/or cameras. Sensor system 324 generally includes onboard sensors which allow autonomous vehicle 101 to safely navigate, and to ascertain when there are objects near autonomous vehicle 101. In one embodiment, sensor system 324 may include propulsion systems sensors that monitor drive mechanism performance, drive train performance, and/or power system levels.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not does not have the capacity to provide sufficient power.

Communications system 340 allows autonomous vehicle 101 to communicate, as for example, wirelessly, with a fleet management system (not shown) that allows autonomous vehicle 101 to be controlled remotely. Communications system 340 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand.

In some embodiments, control system 336 may cooperate with processor 304 to determine where autonomous vehicle 101 may safely travel, and to determine the presence of objects in a vicinity around autonomous vehicle 101 based on data, e.g., results, from sensor system 324. In other words, control system 336 may cooperate with processor 304 to effectively determine what autonomous vehicle 101 may do within its immediate surroundings. Control system 336 in cooperation with processor 304 may essentially control power system 332 and navigation system 312 as part of driving or conveying autonomous vehicle 101. Additionally, control system 336 may cooperate with processor 304 and communications system 340 to provide data to or obtain data from other autonomous vehicles 101, a management server, a global positioning server (GPS), a personal computer, a teleoperations system, a smartphone, or any computing device via the communication module 340. In general, control system 336 may cooperate at least with processor 304, propulsion system 308, navigation system 312, sensor system 324, and power system 332 to allow vehicle 101 to operate autonomously. That is, autonomous vehicle 101 is able to operate autonomously through the use of an autonomy system that effectively includes, at least in part, functionality provided by propulsion system 308, navigation system 312, sensor system 324, power system 332, and control system 336.

As will be appreciated by those skilled in the art, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle101 with perception capabilities. For example, data or information obtained from sensor system 324 may be processed such that the environment around autonomous vehicle 101 may effectively be perceived.

In general, an autonomous vehicle may be arranged to either operate under the control of an autonomy system, or under the control of a remote system such as a teleoperations system or a system that may operate the vehicle through the use of a remote control. While the vehicle operates under the control of an autonomy system, a remote system may operate in a supervisory mode such that a remote operator may effectively monitor the environment around the vehicle using a display of a video feed, and prepare to take over operation of the vehicle if needed. While the vehicle operates under the control of a remote operator using a remote system, the remote system operates in a driving mode such that the remote operator uses a video feed displayed on a display screen to determine how, e.g., where and how fast, to drive the vehicle.

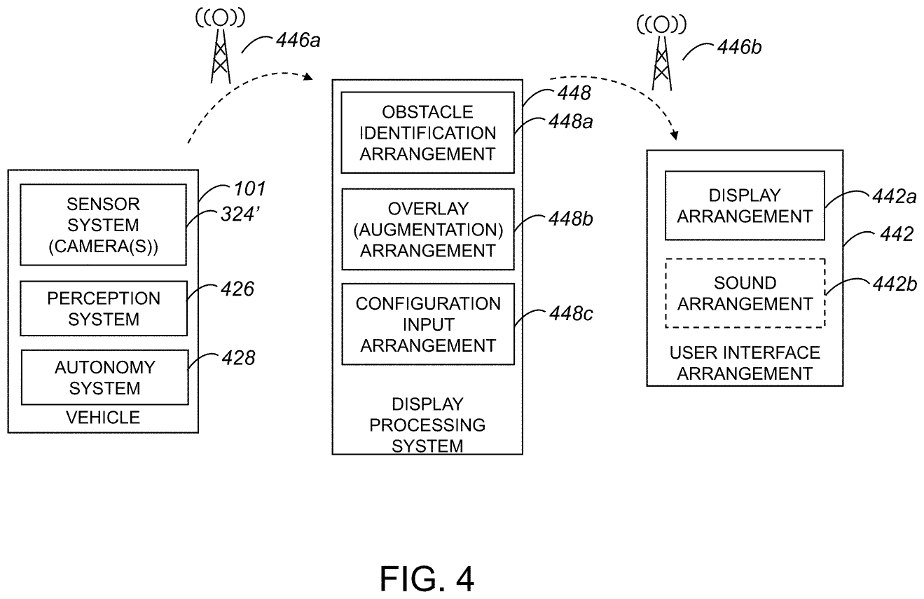

FIG. 4 is a block diagram representation of an overall system which allows for driving and supervisory modes to be presented on a display arrangement in accordance with an embodiment. An overall system includes vehicle 101, a user interface arrangement or element 442, and a display processing system 448. Vehicle 101 may communicate with display processing system 448 over a network 446a, which may be any suitable wireless network including, but not limited to including, a Wi-Fi network, an LTE network, and/or a 3G/4G/5G network.

In the embodiment as shown, display processing system 448 communicates with user interface arrangement 442 over a network 446b. Network 446b may be any suitable network including, but not limited to including, a wireless network such as a Wi-Fi network, an LTE network, and/or a 3G/4G/5G network. It should be appreciated that in some embodiments, display processing system 448 may be local with respect to user interface arrangement 442, e.g., display processing system 448 and user interface arrangement 442 may both be included as part of a teleoperation system.

Vehicle 101 includes sensor system 324′ which may generally include one or more cameras. Such cameras may generally collect visual data relating to the environment around vehicle 101. Vehicle 101 also includes a perception system 426 which may include hardware and/or software which processes data provided by sensor system 324′ to essentially discern or to otherwise perceive the environment around vehicle 101. By way of example, perception system 426 may execute algorithms which identify objects and other aspects indicated in data from sensor system 324′. An autonomy system 428 is generally configured to use information provided by sensor system 324′ and perception system 426 to enable vehicle 101′ to operate autonomously and/or semi-autonomously.

Data collected by sensor system 324′ and perception system 426 or, more generally, systems onboard vehicle 101′, is generally provided to display processing system 448 via network 446a. Display processing system 448 may include hardware and/or software, and includes an obstacle identification arrangement or element 448a, an overlay arrangement or element 448b, and a configuration input arrangement or element 448c. Obstacle identification arrangement 448a is configured to utilize data obtained from sensor system 324′ and/or perception system 426 to identify objects that appear to be obstacles, or objects which may impede or hinder the ability of vehicle 101 to drive or to otherwise operate. Overlay arrangement 448b is configured to identify a type associated with an obstacle, and to determine characteristics of an overlay and/or contextual information associated with the obstacle. In general, overlay arrangement 448b may identify how to augment a scene such that information concerning an obstacle may be conveyed using an overlay and/or contextual information. Configuration input arrangement 448c is arranged to obtain input from vehicle 101 and/or user interface arrangement 442 to determine which obstacles overlay arrangement 448b is to process. For example, when a remote user (not shown) is monitoring vehicle 101 in a driving mode, configuration input arrangement 448c may obtain input data which indicates that overlays may be used to effectively highlight a subset of all obstacles in a scene. Alternatively, when a remote user (not shown) is operating in a supervisory mode, configuration input arrangement 448c may obtain input data which indicates that substantially all obstacles in a scene are to be highlighted by overlays and/or contextual information. Input data may generally be used to enable a configuration of which obstacles are to be highlighted by overlays and/or contextual information to be substantially customized.

User interface arrangement 442, which may be associated with a remote operation system such as a teleoperation system or a remote control system, includes a display arrangement 442a and an optional sound arrangement 442b. Display arrangement 442a generally includes, but is not limited to including, a display screen or a monitor which may be used to display a scene within which obstacles are substantially highlighted using overlays and/or contextual information. In general, display arrangement 442a is any arrangement on which visual information may be rendered.

Optional sound arrangement 442b may include any suitable mechanism which allows audible or audial information to be shared. For example, optional sound arrangement 442b may include a sound generator and/or a speaker.

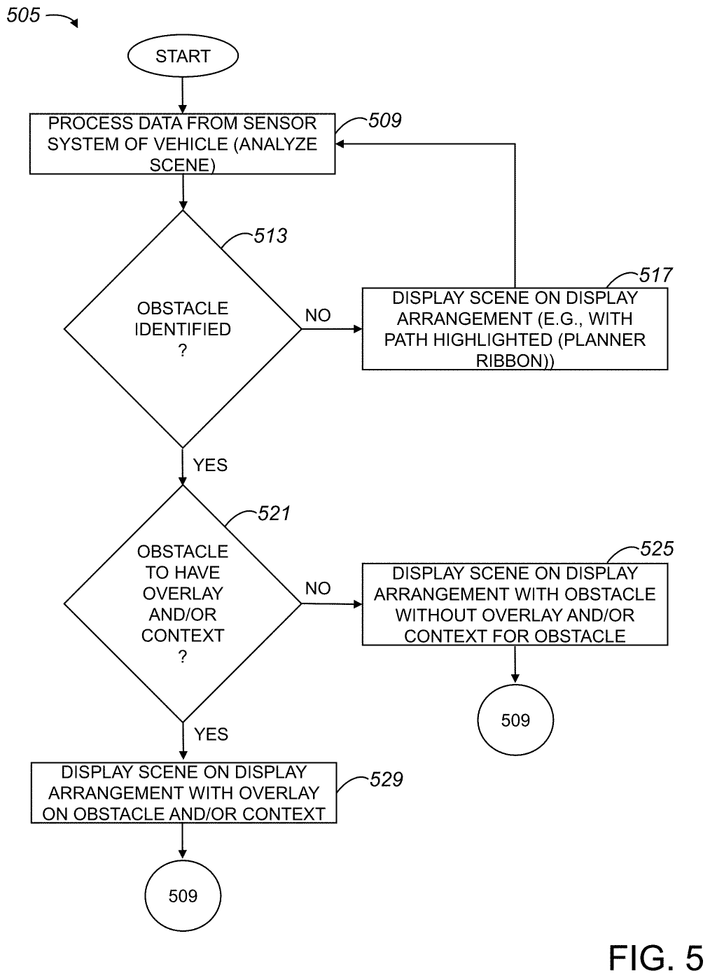

FIG. 5 is a process flow diagram which illustrates a method of displaying information on a display screen, e.g., for use by a remote operator or a teleoperator, in accordance with an embodiment. A method 505 of displaying information on a display screen of a remote system such as a teleoperations system or a remote control system begins at a step 509 in which data from a sensor system of a vehicle is obtained and processed. The sensor data may generally be associated with the environment surrounding the vehicle. For example, sensor data obtained from sensor system 324 and/or a perception system of vehicle 101, as discussed above with respect to FIG.3, may be analyzed to determine what is depicted in or otherwise included in a feed or a scene.

Once data associated with the vehicle is analyzed, a determination is made in a step 513 as to whether an obstacle is identified in the data. That is, it is determined whether the analysis of the data resulted in the identification of one or more obstacles. An obstacle may be any object or feature that may have an effect on a vehicle and/or a path that the vehicle is traveling on. That is, an obstacle may be any object or feature which may cause a change in a vehicle path or, more generally, the operation of a vehicle. For example, obstacles may include, but are not limited to including, vehicles, motorcycles, motorcyclists, bicycles, bicyclists, scooters, wheelbarrows, pedestrians, animals, strollers, shopping carts, and/or traffic cones. Substantially any object that may be in a path of a vehicle, or that may cross into the path of a vehicle, may be considered to be an obstacle.

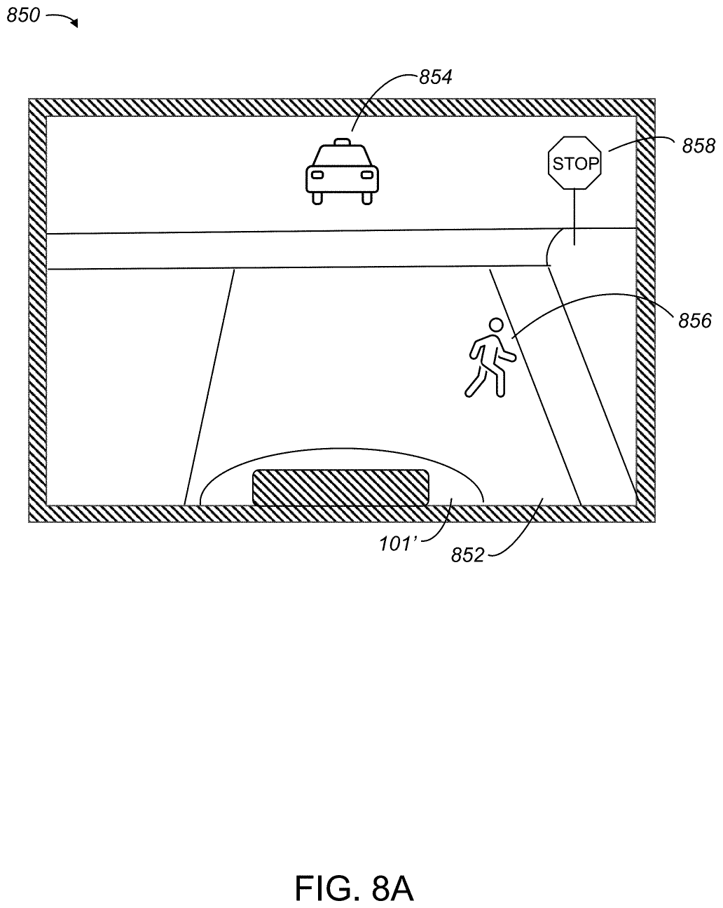

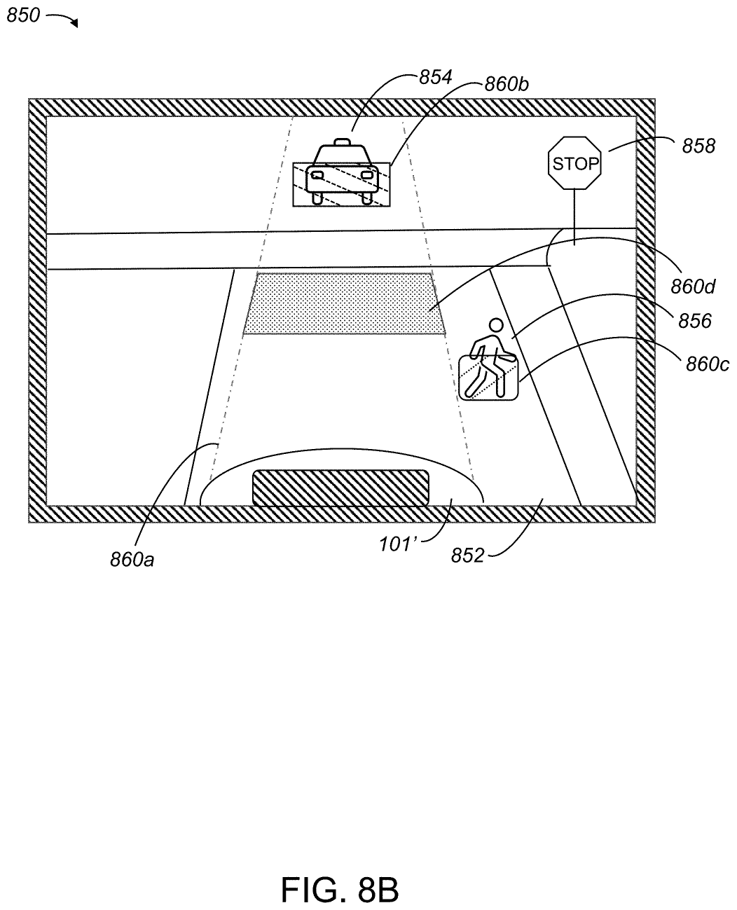

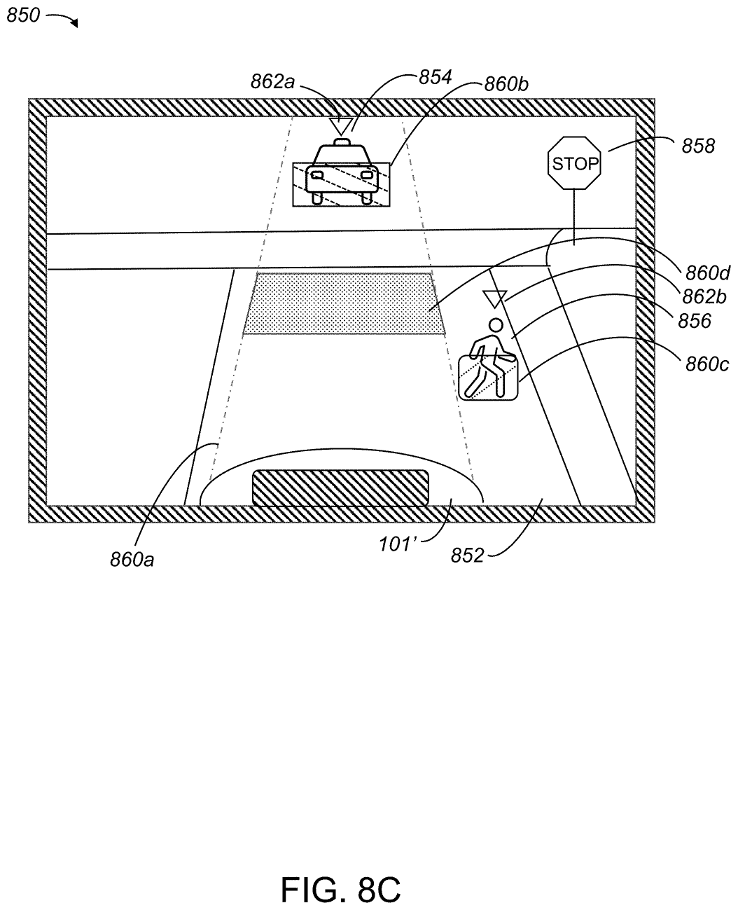

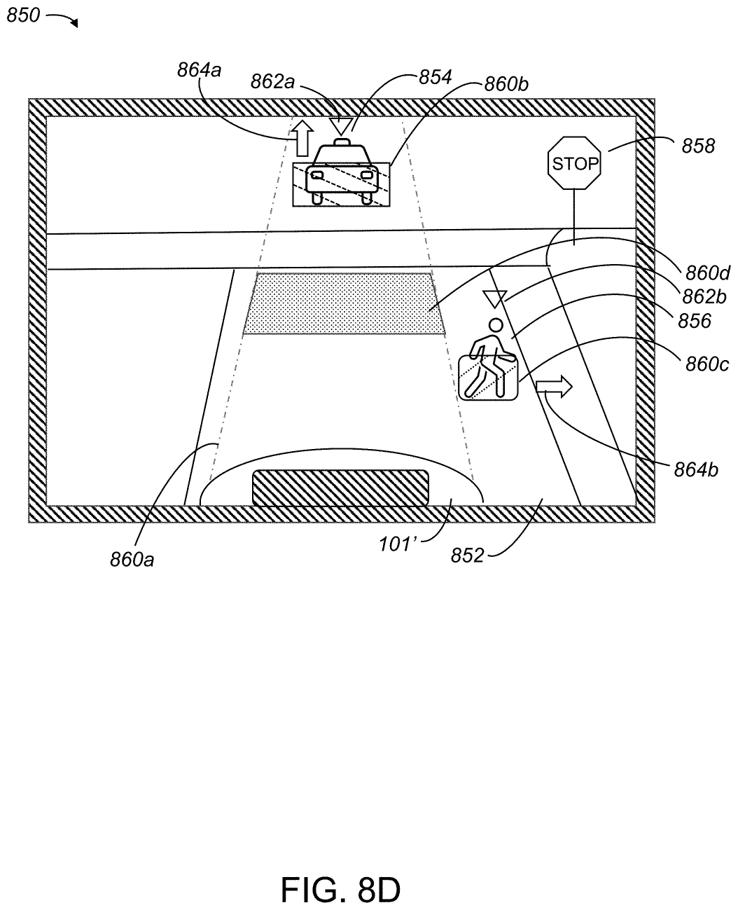

If the determination in step 513 is that no obstacle has been identified, the feed or scene is displayed on a display arrangement, e.g., a display screen of a teleoperation system or a remote control. When there are substantially no obstacles to highlight, the path to be traveled by the vehicle may still be highlighted, as for example by displaying a planner ribbon. A planner ribbon will be discussed below with reference to FIG. 8B. After the feed or scene is displayed, process flow returns to step 509 in which data from a sensor system of a vehicle may be obtained and processed.

Alternatively, if it is determined in step 513 that an obstacle has been identified, then it is determined in a step 521 in whether the obstacle is to have an overlay and/or context. That is, it is determined whether the obstacle is to have an associated indicator configured to enable the obstacle to be substantially identified. It should be appreciated that not every identified obstacle may be displayed on a display screen with an overlay and/or context information. For example, certain types of obstacles may be displayed with overlays when a remote system is operating in supervisory mode, but those types of obstacles may not necessarily be displayed with overlays when the remote system is operating in driving mode. In one embodiment, obstacles which are identified as critical or important, e.g., obstacles which are likely to have an effect on whether a vehicle may remain on an intended path, may be provided with overlays and/or context information. An overlay may generally be overlayed visually on, or effectively superimposed visually over, an obstacle.

If the determination in step 521 is that the obstacle is not to have an overlay and/or context, the scene is displayed on a display arrangement of a remote system with the obstacle depicted but without an overlay and/or context for the obstacle in a step 525, Once the scene is displayed, process flow returns to step 509 in which data from a sensor system of a vehicle continues to be obtained and processed.

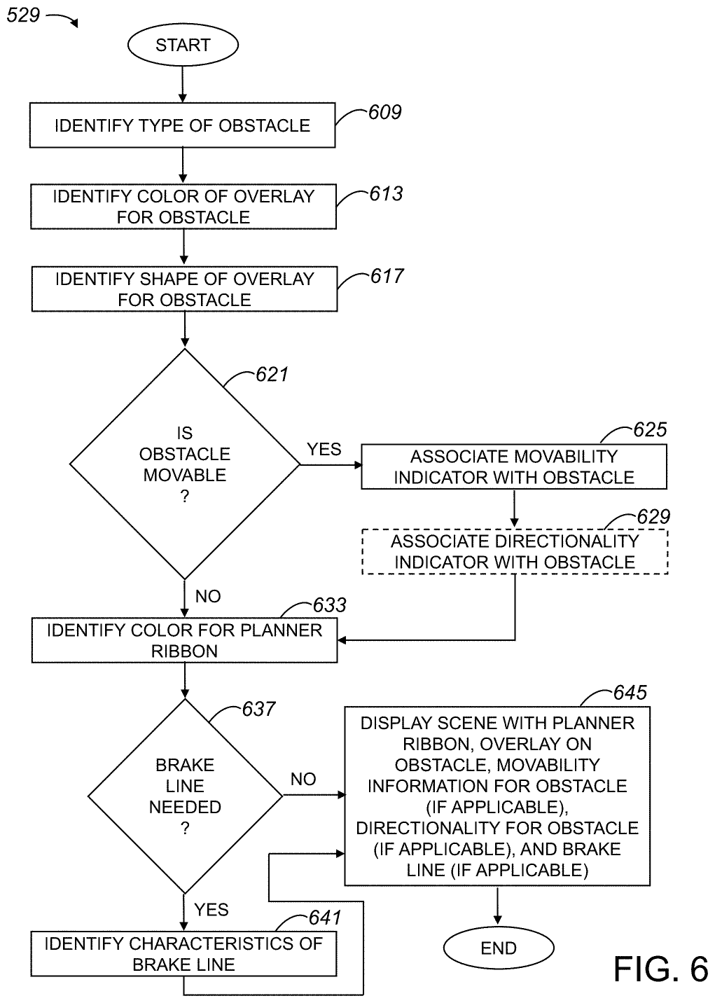

On the other hand, if it is determined in step 521 that the obstacle is to have an overlay and/or context, then in a step 529, a scene is displayed on a display arrangement with an overlay over the obstacle and/or context relating to the obstacle. One method of displaying an overlay and/or context will be discussed below with respect to FIG. 6. It should be appreciated that the configuration of the overlay may vary widely, and that the type of context provided may also vary widely. After the scene is displayed, process flow returns to step 509 in which data from a sensor system of a vehicle continues to be obtained and processed.

With reference to FIG. 6, a method of displaying a scene on a display arrangement with an overlay on an obstacle and/or context, e.g., step 529 of FIG. 5, will be described in accordance with an embodiment. A method 529 of displaying a scene on a display arrangement begins at a step 609 in which a type is associated with an identified obstacle. That is, the type of obstacle detected in step 513 of FIG. 5 is identified. An obstacle may be of any suitable type including, but not limited to including, general types such as potentially moving object types and stationary object types. Moving object types may include, but are not limited to including, vehicles, motorcycles, motorcyclists, bicycles, bicyclists, scooters, wheelbarrows, pedestrians, animals, strollers, and/or shopping carts. Stationary object types may include, but are not limited to including, traffic cones and/or construction signage.

Once a type associated with an obstacle is identified, a color of an overlay for the obstacle is identified in a step 613. In one embodiment, different object types may be associated with different colors, and shades of the colors may be used to identify specific objects within the object types, e.g., a large vehicle may be a dark shade of a color and a small vehicle may be a light shade of the same color. For example, green may indicate a motorized vehicle, yellow may indicate a bicycle, orange may indicate a traffic cone, purple may indicate an animal, and red may indicate a pedestrian. It should be appreciated, however, that the colors selected to indicate object types may vary widely.

In a step 617, a shape for an overlay for the obstacle is identified. It should be appreciated that different types of objects may be identified by the shape of an overlay, in addition to a color. For instance, rounded rectangles may be used to highlight pedestrians, bicycles, and bicyclists, while rectangles may be used to highlight all other objects. Alternatively, each type of object may be identified by a different shape.

From step 617, process flow moves to a step 621 in which it is determined if the obstacle is movable and/or is moving. That is, it is determined whether the object is a stationary object or a moving object. Using sensor data obtained from a sensor system of a vehicle, it may be determined whether an object is movable and/or is moving.

If the determination is that the obstacle is movable and/or is moving, then a movability indication is associated with the obstacle in a step 625. A movability indication may be an icon or character, positioned in the vicinity of the obstacle, which signifies that the obstacle is moving. In one embodiment, a movability indication may be a triangle. Such a triangle may be of the same color as the color of the overlay for the obstacle.

In an optional step 629, a directionality indicator may be associated with the obstacle. Such an indicator may indicate a direction in which the obstacle is moving. For example, a directionality indicator may be an arrow that points in the direction in which the obstacle is moving.

From step 625, or from optional step 629, process flow moves to a step 633 in which one or more colors for a planner ribbon is identified. A planner ribbon generally depicts a route to be traveled by a vehicle, and may be characterized by a color which identifies a route or path, and a color which indicates whether the vehicle is, or will be, accelerating or decelerating. By way of example, a planner trajectory may generally be characterized by one color such as blue which indicates the route of a vehicle, and portions of the path at which the vehicle will be accelerating may be shown in a different color such as green, while portions of the path at which the vehicle may be decelerating may be shown in yet another color such as purple.

A determination is made in a step 637 as to whether a brake line is needed or appropriate to include in a scene on a display screen. It should be appreciated that a brake line may be needed if there is a stop sign or a traffic signal along the path of a vehicle. That is, a brake line may be appropriate if there is an expected point in the substantially immediate path of a vehicle at which the vehicle is anticipated to come to a stop.

If it is determined that a brake line is not needed, the indication is that there is effectively no location along a substantially immediate portion of a path of the vehicle, as for example the portion of the path that is to be displayed on a display arrangement, which includes a stopping point. Accordingly, in a step 645, a scene is displayed on a display arrangement, with the scene including a planner ribbon, an overlay on an obstacle, movability information for the obstacle if applicable, and directionality information for the obstacle if application. Upon displaying the scene, the method of displaying a scene on a display arrangement is completed.

Alternatively, if it is determined in step 637 that a brake line is needed, the characteristics of the brake line are identified in a step 641. For example, the location of the brake line may be identified, and the dimensions of the brake line may be identified. The brake line, which may be a stop fence, may be arranged to be displayed in any suitable color, e.g., red. After the characteristics of the brake line are identified, process flow moves to step 645 in which a scene that includes at least a planner ribbon, an overlay on an obstacle, and the brake line is displayed on a display arrangement.

Returning to step 621, if the determination is that the obstacle is not movable and/or is not moving, the indication is that the obstacle is substantially stationary. As such, process flow moves from step 621 to step 633 in which a color for a planner ribbon is identified.

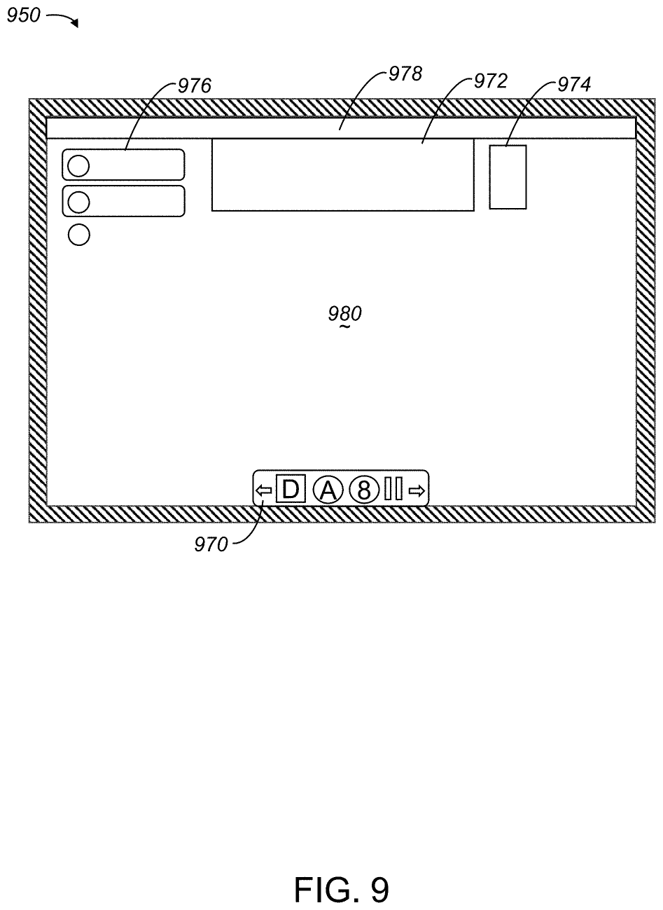

A display arrangement such as display arrangement 442a of FIG. 4 typically includes a display screen on which a virtual console is displayed. In one embodiment, the virtual console may be arranged to include features which are typically included on a dashboard of standard vehicle, e.g., a vehicle which a driver may manually drive. One example of a virtual console will be discussed below with respect to FIG. 9. A scene associated with a feed may be displayed on a display screen, along with a planner ribbon, overlays on obstacles, and/or optional contextual information, such that the scene effectively appears in the virtual console.

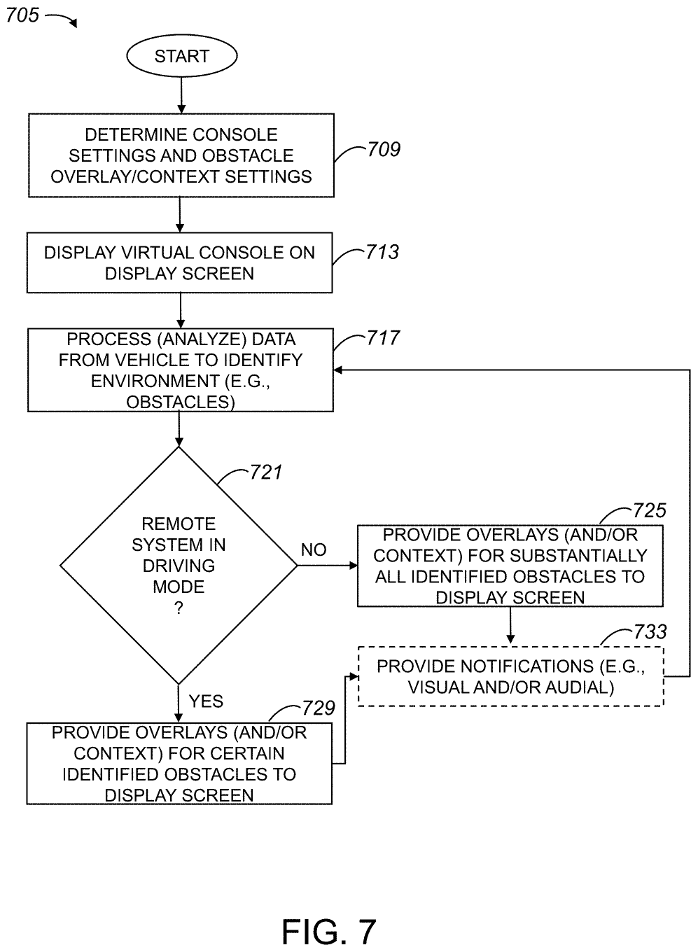

FIG. 7 is a process flow diagram which illustrates a method of providing information on a display arrangement, e.g., a display screen, that includes providing a virtual console in accordance with an embodiment. A method 705 of providing information on a display arrangement such as a display screen begins at a step 709 in which console settings and obstacle overlay and/or context settings are determined. The settings, which may vary, may provide an indication of a type of information that is to be displayed on a display screen, the configurations of overlays, and/or the type of context information that is to be displayed.

In a step 713, a virtual console is displayed on the display screen. The virtual console may be arranged to display controls, statuses, and one or more views associated with a vehicle. Typically, the virtual console is arranged to simulate the view a driver of a vehicle would have. In one embodiment, virtual console may be displayed on more than one display screen.

Once the virtual console is displayed, data obtained from a vehicle may be processed or analyzed in a step 717. Processing the data, as for example data from a sensor system or from a perception system, enables obstacles in the scene or environment of the vehicle to be identified.

A determination is made in a step 721 as to whether a remote system such as a teleoperations system is in a driving mode, i.e., whether the vehicle is being remotely driven by a remote operator such as a teleoperator. If the determination is that the remote system is in a driving mode, then in a step 729, overlays and/or contextual information for certain identified obstacles are provided on the display screen, e.g., in the virtual console. Because the remote system is in driving mode, to prevent the display screen used by a remote operator from becoming cluttered, substantially only some obstacles may be highlighted with overlays and/or contextual information. The obstacles which are highlighted may include, but are not limited to including, substantially only some types of obstacles, substantially only obstacles which are in the immediate path of the vehicle, and/or substantially only obstacles which are within a particular range of the vehicle.

After the overlays and/or contextual information are provided on a display screen, process flow moves to an optional step 733 in which notifications, e.g., visual and/or audial notifications, may be provided. Such notifications may effectively warn a remote operator that there are obstacles along a path of the vehicle. From step 729 or from optional step 733, process flow returns to step 717 in which data continues to be processed to identify obstacles in the environment around the vehicle.

Alternatively, if it is determined in step 721 that the remote system is not in driving mode, the implication is that the remote system is operating in a supervisory mode. As such, in a step 725, overlays and/or contextual information is provided for substantially all identified obstacles, and displayed on the display screen. Once the overlays are provided, process flow proceeds to optional step 733 in which notifications may be provided.

With reference to FIGS. 8A-D, information displayed or depicted on a display screen will be described. FIG. 8A is a diagrammatic representation of a display screen in which a feed, e.g., a scene, is displayed in accordance with an embodiment. A display screen 850, which may be part of a display arrangement of a remote system such as a teleoperations system, is used to render visual information provided by a vehicle such as autonomous vehicle 101′. The visual information may be used by a remote operator to supervise, e.g., to monitor, the environment around vehicle 101′, and to facilitate the remote operation of vehicle 101′.

Display screen 850 shows a front view from the perspective or point-of-view of vehicle 101′, although display screen 850 may generally show any suitable view from the perspective of vehicle 101′. The scene depicted on display screen 850 includes a road 852 on which vehicle 101′ is operating, a second vehicle 854, a pedestrian 856, and a stop sign 858.

Second vehicle 854 and pedestrian 856 may be identified as obstacles, as both second vehicle 854 and pedestrian 856 are essentially present along a path (not shown) that vehicle 101′ is traveling. FIG. 8B is a diagrammatic representation of a display screen 850 in which overlays are provided for obstacles in accordance with an embodiment. An overlay 860b is provided to highlight second vehicle 854, and an overlay 860c is provided to highlight pedestrian 856. Overlay 860b is visually depicted such that overlay 860b is superimposed over second vehicle 864 such that at least an outline of second vehicle 854 is essentially visible. Overlay 860c is visually depicted such that overlay 860c is superimposed over pedestrian 856 such that at least an outline of pedestrian 856 is essentially visible. In one embodiment, second vehicle 854 and pedestrian 856 may be considered to be important or critical obstacles. As mentioned above, overlays 860b, 860a may be of particular shapes and/or colors which are associated with obstacle types. A ribbon planner 860a is shown to indicate a path along which vehicle 101′ is expected to travel. A stop line 860d indicates where along the path vehicle 101′ may be braking to a stop.

In one embodiment, an indication of whether an obstacle is movable or moving may be provided on display screen 850. FIG. 8C is a diagrammatic representation of display screen 850 in which movability of obstacles is indicated in accordance with an embodiment. Icons or indicators 862a, 862b are arranged near obstacles 854, 856, respectively, to indicate that obstacles 854, 856 are moving or capable of moving. As shown, icons 862a, 862b are shown as triangles, although it should be appreciated that icons 862a, 862b may be of any suitable shape and are not limited to being triangles. Icon 862a is shown above second vehicle 854 to indicate that second vehicle 854 is movable or moving, and icon 862b is shown above pedestrian 856 to indicate that pedestrian 856 is movable or moving.

In addition to icons 862a, 862b which indicate when an obstacle is movable or moving, a direction of movement may also be indicated in some instances. Referring next to FIG. 8D, display screen 850 is shown with directions of movement indicated for second vehicle 854 and pedestrian 856 in accordance with an embodiment. An arrow 864a depicted near second vehicle 854 indicates a direction in which second vehicle 854 is moving, and an arrow 864b depicted near pedestrian 856 indicates a direction in which pedestrian 856 is moving.

A virtual console on which a scene may be displayed may be rendered on a display screen of a display arrangement. A virtual console may generally include any type of information which may be useful to a remote operator who is either supervising the operation of an autonomous vehicle or remotely operating the vehicle. FIG. 9 is a diagrammatic representation of layouts of control indicators and notifications with respect to a display in accordance with an embodiment. A display screen 950 displays a virtual console that includes a dashboard 970, an alternate view window 972, a traffic light indicator 974, at least one notification indicator 976, and a status bar 978. It should be understood that in some embodiments, display screen 950 may include a subset of dashboard 970, alternate view window 972, traffic light indicator 974, notification indicator 976, and status bar 978.

Dashboard 970 may include any number of indicators including, but not limited to including, a gear state, an autonomy state, a speedometer, a brake input, a throttle input, and/or turn signals. The gear state may generally indicate whether a vehicle is in a drive gear, a reverse gear, or a park gear. The autonomy state may indicate whether a vehicle is operating in autonomous mode or in another mode, e.g., under the control of a remote operator or in a substantially manual mode. The speedometer may provide an indication of a current speed of a vehicle and may, in one embodiment, also provide an indication of a substantially maximum permissible speed. The brake input may indicate whether braking is currently taking place. The throttle input may indicate whether a throttle is effectively active. The turn signals indicate whether a turn signal, e.g., a left turn signal or a right turn signal, is activated.

While a main portion 980 of display screen 950 may provide a primary view, e.g., a front view, alternative view window 972 may provide a different view. For example, alternate view window 972 may provide a rear view. That is, alternate view window 972 may substantially serve the same purpose as a standard rear view mirror.

Traffic light indicator 974 may depict a traffic light, and may indicate whether there is an upcoming traffic light along the path of a vehicle. If there is an upcoming traffic light along the path of the vehicle, traffic light indicator 974 may indicate whether the traffic light is red, yellow, or green. It should be appreciated that if there is no upcoming traffic light along the path of the vehicle, traffic light indicator 974 may not be present. That is, traffic light indicator 974 may be displayed substantially only when there is an upcoming traffic light.

One or more notification indicators 976 may include one or more messages. The messages may include full messages and/or minimized messages. Notification indicator 976 may provide, but is not limited to providing, an indication of whether there is an upcoming traffic light, whether there is an upcoming yield, whether there is an upcoming stop, whether there is an upcoming pull over, and/or whether there is an upcoming speed bump.

Status bar 978 may be configured to provide a vehicle indicator and/or a health status of a vehicle. For example, status bar 978 may identify a vehicle identification number of the vehicle, and may include an indication of whether the vehicle is healthy, degraded, or unhealthy.

When a vehicle is be monitored or operated remotely, a communications network which facilitates the monitoring or operating of the vehicle may have an associated latency. As will be appreciated by those skilled in the art, latency is generally an amount of time that elapses between when data is provided by a source and obtained by a destination. Thus, latency may be associated with how much time it takes for data to be transmitted or sent by a vehicle and received by a system such as a display processing system, a monitoring system, and/or a remote teleoperations system, and vice versa. That is, the delay between when a signal is transmitted and when the signal is received is typically an indicator of latency. Information relating to how much latency is present within an overall system may be provided to a monitoring and/or teleoperations system such that, for example, network issues may be identified, and steps may be taken to substantially mitigate the network issues. In one embodiment, a latency meter or indicator may be provided as part of a virtual console, as for example as part of status bar 978 displayed as part of a virtual console rendered on display screen 950 of FIG. 9.

When a latency indication is provided as part of a virtual console, the latency indication may be rendered or otherwise displayed in any suitable form. For example, the latency indication may be a meter which indicates a general amount of latency. The latency indication may also be arranged to display colors which indicate a general amount of latency, e.g., a red color may indicate a relatively high amount of latency while a green color may indicate a relatively low amount of latency. A remote operator utilizing a virtual console may understand, through viewing a latency indication, whether a vehicle may continue to drive safely, whether extra caution should be exercised while driving the vehicle remotely, and/or whether it may be prudent to remove the vehicle from roads until latency reaches an acceptable level.

In one embodiment, a latency indication may be provided as a measure of a delay associated with frames that are received, e.g., by a monitoring and/or teleoperations system. The latency indication may include a video frame rate measured in frames per second and an indication of an amount of delay. A gap between two frames, or frame jitter, may be measured. If the frame jitter is larger than a threshold value, the amount of latency present may be higher than desired or acceptable. For example, within an approximately one second window, approximately thirty frames may be expected within an approximately thirty-three millisecond interval. If fewer than thirty frames are obtained within a one second window, latency may be indicated. A latency indication may be represented as a network quality bar that is part of a visual display. Alternatively, a latency indication may be represented by substantially graying out video displayed on a visual display until new frames are received. It should be appreciated that when video frames are obtained from more than one communications source, as for example when video frames are obtained from multiple modems, the latency indication may include a latency for each source and/or an overall latency that is calculated based on the latencies of the sources.

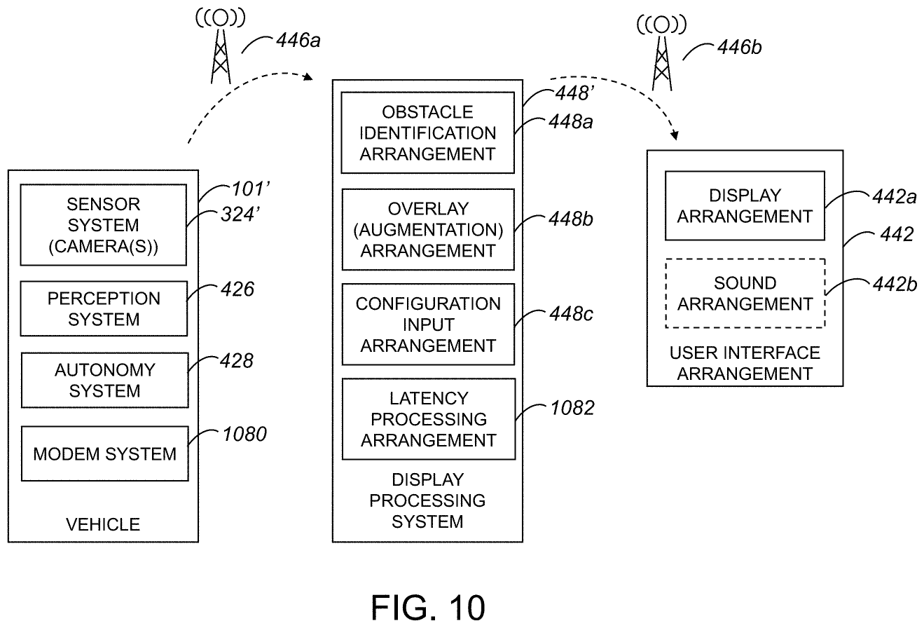

To determine a latency associated with communications between a vehicle and a monitoring system, a display processing system such as display processing system 448 may include hardware and/or software logic for assessing latency. With reference to FIG. 10, an overall system that includes a display processing system e.g., display processing system 448 of FIG. 4, which allows for driving and supervisory modes to be presented on a display arrangement, in addition to providing an indication of latency, will be described in accordance with an embodiment. An overall system includes vehicle 101′, user interface arrangement 442, and display processing system 448′. Vehicle 101′ may communicate with display processing system 448′ over network 446a, while display processing system 448′ may communicate with user interface arrangement 442 over network 446b.

When information relating to the latency associated with the overall system is to be provided, the latency may be monitored and/or calculated by a latency processing arrangement 1082 of display processing system 448′ using information obtained from a modem system 1080 of vehicle 101′ or, more generally, a communications system (not shown) of vehicle 101′. Modem system 1080 is configured to transmit data, e.g., frames of video data, using one or more channels associated with network 446a. Latency processing arrangement or element 1082 is configured to receive or to otherwise obtain the data, and to determine how much time has elapsed between a time when the data was sent and a time when the data was received. In one embodiment, latency processing arrangement 1082 may account for an amount of time that elapses between when data is sent from vehicle 101′ to when the data is received by user interface arrangement 442 and/or a video frame rate for frames received by user interface arrangement 442.

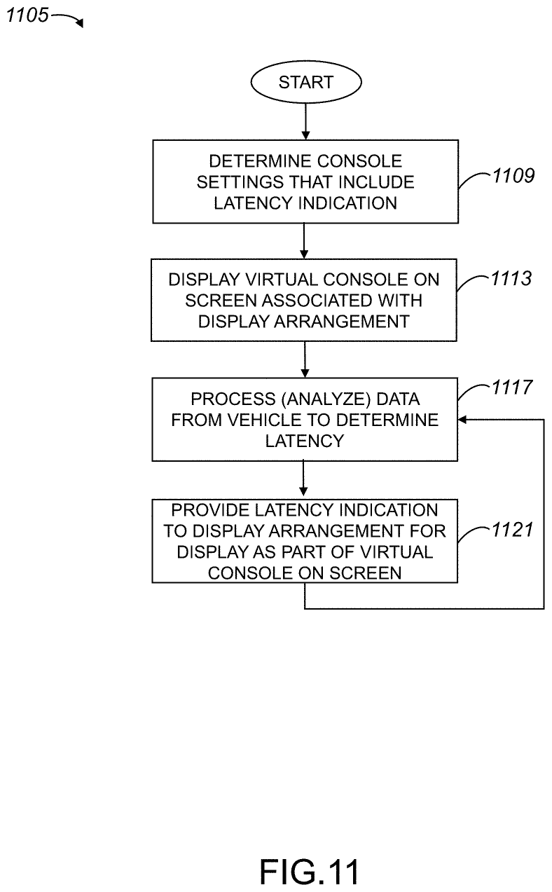

FIG. 11 is a process flow diagram which illustrates a method of displaying latency information on a display screen, e.g., for use by a remote operator or a teleoperator that is monitoring and/or operating a vehicle, in accordance with an embodiment. A method 1105 of displaying latency information on a display screen begins at a step 1109 in which console settings that include a latency indication are determined or otherwise obtained. The console settings may specific context and overlays, in addition to a latency indication.

In a step 1113, a virtual console is displayed on a display screen, e.g., a display screen associated with a teleoperations system which enables a vehicle to be operated remotely. Once the virtual console is displayed, data obtained from a vehicle is processed or analyzed to determine latency in a step 1117. Data may be processed to determine a time difference between when data is sent and received. Data may also be processed to determine a rate at which frames are received.

After latency is determined, a latency indication is provided to a display arrangement in a step 1121. The display arrangement causes the latency indication to be displayed as part of a virtual console on a screen. As previously mentioned, the latency indication may be displayed such that an actual measure of latency is shown and/or such that a general level of latency is depicted. Upon providing a latency indication to the display arrangement, process flow returns to step 1117 in which data from the vehicle continues to be processed to determine latency.

As described above with respect to FIGS. 8A-D, a stop line such as stop line 860d may indicate where along a path a vehicle such as vehicle 101′ may be braking to a stop under the control of a teleoperator who is remotely controlling the vehicle. In one embodiment, in lieu of, or in addition too, a stop line, a stop fence may provide an indication of where an autonomy system is expected to cause the vehicle to come to a stop. In other words, a stop fence may indicate where a vehicle may come to a substantially complete, or absolute, stop if the vehicle continues to operate in autonomous mode. That is, a stop fence may be a visual representation configured to identify where on a road a vehicle may come to a substantially absolute stop under the control of autonomy, while a stop line may be a visual representation configured to identity where on a road a vehicle may come to a stop under the control of a teleoperator.

Where a stop fence may be placed in a visual representation may generally be determined by processing information obtained from a sensor system of a vehicle, for example, and determining at which point the vehicle may come to a substantially absolute stop given factors including, but not limited to including, the speed at which the vehicle is traveling, the environment in which the vehicle is traveling, the obstacles in the environment, the braking capabilities of the vehicle, and/or the distance between the current location of the vehicle and a location at which the vehicle is expected to come to a stop.

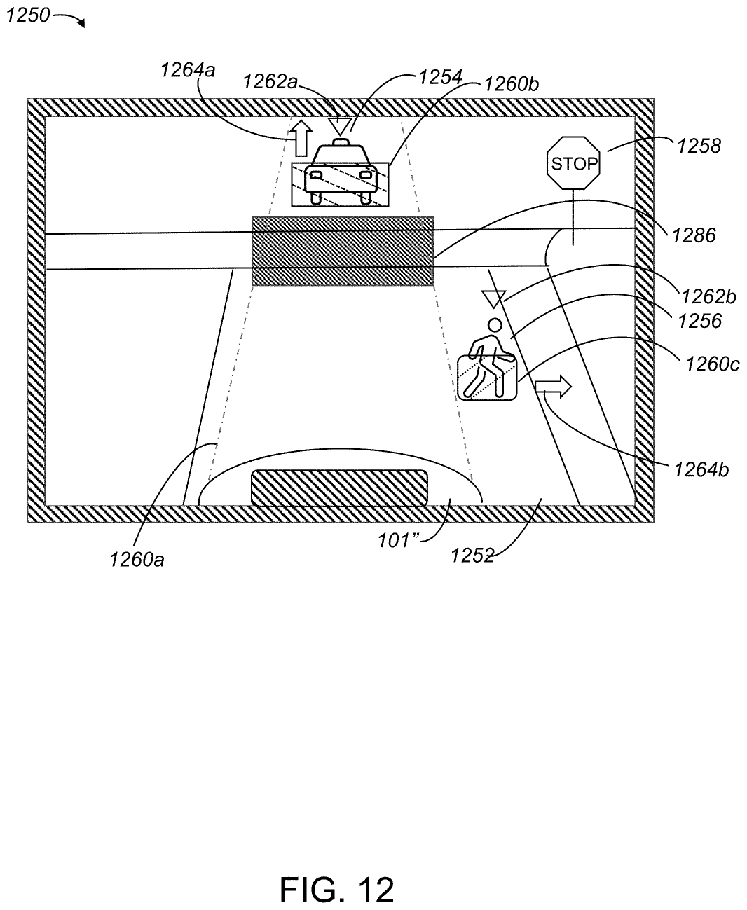

FIG. 12 is a diagrammatic representation of a display, e.g., a virtual display, in which a stop fence is indicated in accordance with an embodiment. A display screen 1250, which may be part of a display arrangement of a remote system such as a teleoperations system, renders visual information provided by a vehicle such as autonomous vehicle 101″. The visual information may be used by a remote operator to supervise the operation of vehicle 101″ in the scene or environment around vehicle 101′ and to facilitate the remote operation of vehicle 101″ when it is determined that vehicle 101″ should be operated remotely rather than under the control of an autonomy system.

Display screen 1250 shows a front view from the perspective or point-of-view of vehicle 101″, although display screen 1050 may generally show any suitable view from the perspective of vehicle 101″. Display screen 1050 includes representations of a road 1052 on which vehicle 101″ is operating, a second vehicle 1254, a pedestrian 1256, and a stop sign 1258.

An overlay 1260b is provided to highlight second vehicle 1254, and an overlay 1260c is provided to highlight pedestrian 856. Icons or indicators 1262a, 1262b are arranged near obstacles 1254, 1256, respectively, to indicate that obstacles 1254, 1256 are moving or capable of moving. An arrow 1264a depicted near second vehicle 1254 indicates a direction in which second vehicle 1254 is moving, and an arrow 1264b depicted near pedestrian 1256 indicates a direction in which pedestrian 1256 is moving.

A ribbon planner 1260a is shown to indicate a path along which vehicle 101″ is expected to travel, e.g., under the control of an autonomy system. A stop fence 1286 indicates where along the path vehicle 101″ is expected to come to a substantially complete or absolute stop under the control of an autonomy system. A location for stop fence 1286 may be determined based on information obtained from sensors and/or an autonomy system. Stop fence 1286 may represented using any suitable shape and/or color. As shown, stop fence 1286 is arranged substantially atop ribbon planner 1260a to indicate that stop fence 1286 is along a path which vehicle 101″ is expected to travel. In one embodiment, stop fence 1286 may be represented as a substantially upright feature rather than as a substantially two-dimensional ribbon along a path which vehicle 101″ is expected to travel. Stop fence 1286 may be substantially transparent such that any objects along the path which vehicle 101″ I expected to travel that are past stop fence 1286 may be visible.

Although only a few embodiments have been described in this disclosure, it should be understood that the disclosure may be embodied in many other specific forms without departing from the spirit or the scope of the present disclosure. By way of example, identified obstacles have been described as being displayed or otherwise depicted with overlays thereon which effectively identify types associated with the obstacles. However, substantially any visual indicator may be used to identify a type associated with an obstacle. In other words, visual indicators used to identify obstacles in a feed or a scene are not limited to being overlays. For instance, visual indicators may include, but are not limited to including, underlays, outlines, and/or icons such as icons positioned on or near obstacles.

While colors and shapes have been described as being used in overlays of obstacles in a scene to effectively identify and highlight the obstacles, overlays are not limited to being characterized by colors and shapes. For instance, patterns and/or differing levels of transparency in an overlay may be used, in lieu of colors, to identify object types. In some instances, the size of an overlay may correspond to a type of object. Generally, any suitable representation of an obstacle or an object which effectively identifies a type associated with the obstacle or object may be implemented on a virtual display. Overlays and visual indicators may generally be graphical indicators, although it should be understood that overlays and visual indicators may include words and/or numbers without departing from the spirit or the scope of the disclosure.

As previously mentioned, overlays or visual indicators may generally be provided for obstacles or objects which are identified as important or critical. Whether a particular obstacle or object is considered to be important may vary depending upon factors including, but not limited to including, obstacles which may interfere with the travel of a vehicle, the relative sizes of obstacles, and/or general requirements of a particular enterprise. By way of example, vehicles and pedestrians may be categorized as important even if they aren't currently moving. In addition, traffic signs may be categorized as important even if they are stationary, while other substantially permanently stationary objects may generally be categorized as less important. That is, in some embodiments, traffic signs or signals may be provided with overlays or visual indicators. When an overlay is a particular color, the vibrancy of the color may be arranged to indicate how important, or critical, the obstacle is considered to be. For instance, a more vibrant or intense version of a color may be used to identify a particularly important obstacle.

In general, a display arrangement which effectively implements overlays to be displayed as part of a virtual display may obtain data from a vehicle. It should be appreciated that the display arrangement may also obtain information from other sources, and is not limited to obtaining data from a vehicle. For example, a display arrangement or display processing system may obtain information from sources including, but not limited to including, traffic cameras, cameras associated with monitoring road infrastructure, and/or other vehicles.

A display processing system such as display processing system 448 of FIG. 4 has generally been described as being remote with respect to a vehicle. In one embodiment, a display processing system may be included on a vehicle and may communicate with a user interface arrangement, as for example a display arrangement, over a network to enable a feed or a scene to be displayed on the display arrangement.

As shown in FIG. 12, a stop fence, or an indication of where along a path a vehicle under the control of an autonomy system is expected to come to an absolute stop, may be provided on a visual display in addition to overlays and/or context indicators. It should be appreciated that a stop fence may be depicted with or without overlays and/or context information without departing from the spirit or the scope of the disclosure.

A remote system such as a teleoperations system may generally include display screens and a virtual console as described above. It should be appreciated that in some instances, a remote system may include multiple display screens and/or multiple virtual consoles which may display different views relating to the environment around a vehicle. For example, a remote system may include display screens which show front, side, rear, and/or top down views of a vehicle. In one embodiment, a remote system may include different screens which display views from different cameras or other sensors mounted on a vehicle. Such different screens may include a primary screen which shows either a front view and/or a rear view, as well as secondary screens which show side views. Display screens may also include screens which display a view similar to a view which may be provided by a rear-view mirror and/or a side-view mirror.

In one embodiment, when it is determined that an autonomous vehicle is to pull over to the side of a road, or pull out from the side of the road, an overlay may be rendered on a display screen to indicate where the pull over or the pull out is to occur. For example, a pullover overlay may be represented as a line in a visual display that indicates where the pullover is to occur. Alternatively, a pullover overlay may be represented as an outlined area that essentially represents where a vehicle will come to a stop when the vehicle is pulled over to the side of a road.

A latency indication that is provided as part of a visual display may include colors which are intended to show a level of latency. By way of example, red may indicate an unacceptable amount of latency, yellow may indicate an acceptable but less than desirable amount of latency, and green may indicate an amount of latency that is considered to be more than acceptable or desirable. An unacceptable amount of latency may be an amount of latency that is approximately forty percent or more below a desired level, and an acceptable amount of latency may be an amount of latency that is between approximately twenty percent and approximately forty percent below a desired level.

As mentioned above, video displayed on a display screen may be grayed out and/or frozen if an amount of latency associated with signal transmission is below acceptable levels. In one embodiment, video may be frozen if the amount of latency is approximately forty percent or more below a desired level.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, elements, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples are not to be limited to the details given herein, but may be modified within the scope of the appended claims.

What is claimed is:

1. A method comprising:
identifying, in a scene around a vehicle, at least a first object, wherein the at least first object is identified using data obtained from a sensor system of the vehicle;
determining a first type associated with the at least first object;
identifying at least a first indicator associated with the first type; and
providing the at least first indicator associated with the first type to a display arrangement configured to display the scene and the at least first indicator.

2. The method of claim 1 wherein the at least first indicator includes a first overlay, the first overlay being arranged to overlay the at least first object when the scene is displayed by the display arrangement.

3. The method of claim 2 further including:
analyzing the data obtained from the sensor system;
determining whether the at least first object is movable;
identifying a second indicator associated with the at least first object when the at least first object is movable, wherein the second indicator is arranged to indicate that the at least first object is movable; and
providing the second indicator to the display arrangement, the display arrangement further being arranged to display the second indicator when the scene is displayed by the display arrangement.

4. The method of claim 3 further including:
determining a directionality associated with the at least first object, the directionality arranged to identify a direction in which the at least first object is moving;
identifying a third indicator associated with the at least first object, wherein the third indicator is arranged to indicate the directionality of the at least first object; and
providing the third indicator to the display arrangement, the display arrangement further being arranged display the third indicator when the scene is displayed by the display arrangement.

5. The method of claim 2 wherein the overlay has at least one selected from a group including a shape and a color, the shape and the color being specific to the first type.

6. The method of claim 1 further including:
determining whether to provide brake indicator, the brake indicator configured to indicate a location at which the vehicle is anticipated to come to a stop; and
providing the brake indicator to the display arrangement configured to display the brake indicator and the scene.

7. The method of claim 6 wherein determining whether to provide the brake indicator includes obtaining data from an autonomy system associated with the vehicle and analyzing the data obtained from the autonomy system.

8. The method of claim 1 further including:
identifying, in the scene around the vehicle, a second object, wherein the second object is identified using the data obtained from the sensor system of the vehicle;
determining a second type associated with the second object;
identifying a second indicator associated with the second type; and
providing the second indicator associated with the second type to the display arrangement configured to display the scene and the second indicator, wherein the first indicator includes a first overlay arranged to be displayed in the scene over the first object and wherein the second indicator includes a second overlay arranged to be displayed in the scene over the second object, the first overlay and the second overlay are different overlays.

9. Logic encoded in one or more tangible non-transitory, computer-readable media for execution and when executed operable to:
identify, in a scene around a vehicle, at least a first object, wherein the at least first object is identified using data obtained from a sensor system of the vehicle;
determine a first type associated with the at least first object;
identify at least a first indicator associated with the first type; and
provide the at least first indicator associated with the first type to a display arrangement configured to display the scene and the at least first indicator.

10. The logic of claim 9 wherein the at least first indicator includes a first overlay, the first overlay being arranged to overlay the at least first object when the scene is displayed by the display arrangement.

11. The logic of claim 10, wherein the logic is further operable to:
analyze the data obtained from the sensor system;
determine whether the at least first object is movable;
identify a second indicator associated with the at least first object when the at least first object is movable, wherein the second indicator is arranged to indicate that the at least first object is movable; and
provide the second indicator to the display arrangement, the display arrangement further being arranged to display the second indicator when the scene is displayed by the display arrangement

12. The logic of claim 11, wherein the logic is further operable to:
determine a directionality associated with the at least first object, the directionality arranged to identify a direction in which the at least first object is moving;
identify a third indicator associated with the at least first object, wherein the third indicator is arranged to indicate the directionality of the at least first object; and
provide the third indicator to the display arrangement, the display arrangement further being arranged to display the third indicator when the scene is displayed by the display arrangement.

13. The logic of claim 10 wherein the overlay has at least one selected from a group including a shape and a color, the shape and the color being specific to the first type.

14. The logic of claim 9, the logic further operable to:
determine whether to provide brake indicator, the brake indicator configured to indicate a location at which the vehicle is anticipated to come to a stop; and
provide the brake indicator to the display arrangement configured to display the brake indicator and the scene.

15. The logic of claim 14 wherein the logic operable to determine whether to provide the brake indicator is operable to obtain data from an autonomy system associated with the vehicle and to analyze the data obtained from the autonomy system.

16. The logic of claim 9 further operable to:
identify, in the scene around the vehicle, a second object, wherein the second object is identified using the data obtained from the sensor system of the vehicle;
determine a second type associated with the second object;
identify a second indicator associated with the second type; and
provide the second indicator associated with the second type to the display arrangement configured to display the scene and the second indicator, wherein the first indicator includes a first overlay arranged to be displayed in the scene over the first object and wherein the second indicator includes a second overlay arranged to be displayed in the scene over the second object, the first overlay and the second overlay are different overlays.

17. An apparatus comprising:
a first element, the first element configured to identify at least a first object in a scene around a vehicle using data obtained from the vehicle, the first element further being configured to determine a first type associated with the at least first object; and
a second element, the second element configured to identify a first indicator associated with the first type, wherein the second element is further configured to provide the first indicator to a display element arranged to display the scene and the first indicator, the first indicator including an overlay arranged to be displayed over the first object in the scene.

18. The apparatus of claim 17 wherein the first element and the second element cooperate to determine whether the at least first object is movable and, when it is determine that the at least first object is movable, the first element and the second element cooperate to identify a second indicator associated with the at least first object, the second indicator being arranged to indicate that the at least first object is movable, and to provide the second indicator to the display arrangement, the display arrangement further being arranged to display the second indicator when the scene is displayed by the display arrangement.

19. The apparatus of claim 18 wherein the first element and the second element further cooperate to determine a directionality associated with the at least first object, the directionality arranged to identify a direction in which the at least first object is moving, the first element and the second element still further cooperate to identify a third indicator associated with the at least first object, the third indicator is arranged to indicate the directionality of the at least first object, and to provide the third indicator to the display arrangement, the display arrangement further being arranged to be displayed when the scene is displayed by the display arrangement.

20. The apparatus of claim 17 wherein the overlay has at least one selected from a group including a shape and a color, the shape and the color being specific to the first type.

21. The apparatus of claim 17 further including:
a third element, the third element being configured to determine a latency associated with communications between the apparatus and the vehicle, wherein the first element and the second element are configured to cooperate to provide a latency indicator which indicates the latency to the display arrangement to be displayed when the scene is displayed by the display arrangement.
